(19) United States
(12) Patent Application Publication
(10) Pub. No.: US 2018/0012670 A1
(43) Pub. Date: Jan. 11, 2018

(54) DEVICE FOR RECLAMATION OF A RADIOACTIVE HIGH LEVEL WASTE FOR ENERGY CONSUMPTION

(71) Applicant: Shawn Robinson, Nipomo, CA (US)

(72) Inventor: Shawn Robinson, Nipomo, CA (US)

(21) Appl. No.: 15/205,609

(22) Filed: Jul. 8, 2016

(51) Int. Cl. G21F 3/00

(52) U.S. Cl. CPC G21F 3/00

(57) ABSTRACT

A device for reclamation of radioactive high level wastes (HLW) for energy consumption comprises a containment shell that comprises a first closing/opening shell lid having an opening to push the radioactive material in one direction and to dispose the radioactive material out of a second closing/opening shell lid. At least one interchangeable buffer plate having a temperature resistant side is in contact with and bolted to the at least one side of the containment shell. A bimetallic band or cable is being curved and having a higher and a lower linear coefficient of thermal expansion. A gear assembly is adapted to be mounted on the support and meshing with the bimetallic band or cable to control the speed of the device. The device has a potential to consume many materials deemed as waste from various stockpiles and/or from power plants as high level radioactive substances to power itself and subsequently create power from sources of energy deemed otherwise unattainable. Also it has the ability to power select devices being used at power plants that would necessitate motor-driven capabilities even in conjunction with a vehicle, for example, turbines, fuel cells, propellers and/or tires

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

The present invention relates in general to the field of reclamation of radioactive wastes, and more particularly, to a device for reclamation of radioactive high level waste for energy consumption.

### DISCUSSION OF RELATED ART

The release of radioactive material into the environment is a compelling problem. Radioactive wastes are typically the by-products of nuclear power generation and other systems that rely upon nuclear fission or nuclear technology. Radioactive contamination is also extremely problematic when damage occurs to a nuclear power generating station, which can result in the atmospheric release of radioactive material and widespread contamination of the surrounding land.

An existing process for removing radioactive plastic wastes comprises an apparatus for encapsulating radioactive plastic wastes, particularly radioactively contaminated ion exchange filter material containing water in a bituminous solidification substance. The radioactive waste is dried first and then added to the bituminous substance and mixed at a temperature of 120° C. or lower. This process encapsulates the dry radioactive waste into a container. However, such an apparatus can result in radiation leakage resulting in the exposure of the workers involved in the operation to hazardous, which can cause severe illness. There is also a known prior art related to an apparatus that enables the storage of radioactive wastes and the recovery of the extraneous heat emitted from the process. Yet even though that emitted heat is captured it is not utilized to create further energy. However, this system does not provide a containment shell for protection from radiation exposure which might occur during transportation.

Another existing process and apparatus for treating radioactive waste comprises steps whereby waste is admitted to a dual 90 degree conveyor system, one of which transfers waste to an incinerator where the waste is burned to ashes. The ashes are then transferred via vacuum for compaction. The exhaust is then filtered prior to dispensation to the atmosphere. However, such an apparatus does not provide a containment shell that protects those who might be exposed to radiation in the event of a radiation leak accident.

Therefore, there is need for a safe device for the reclamation of high-level radioactive for energy consumption. Such a needed device would offer a containment shell for the storage of radioactive waste. It would contain at least one interchangeable buffer plate to enhance the longevity and integrity of the containment shell. Further, such a needed device would provide at least one bimetallic band of many possible shapes with a higher and a lower linear coefficient of thermal expansion. Furthermore, such a needed device would provide a gear assembly mounted on the support that meshes with the bimetallic band to control the speed of the device based upon degree of contact of the at least one band or cable etc. Finally, such a needed device would provide at least one control arm to control the gear assembly. The at least one controlling arm provides support for additional cooling systems modifications to be attached to increase heating coefficient ratios. The present invention accomplishes these objectives.

### SUMMARY OF THE DISCLOSURE

The present embodiment is a device for reclamation of a radioactive high level waste (HLW) for energy consumption and comprises a containment shell for storage of radioactive material as well as diminishing stores of left over stockpiled high level radioactive waste. The containment shell comprises a first closed shell having an opening to push the radioactive material in one direction and dispose the radioactive material out the back opening into any secondary diminished radioactivity long-term containment shell. The at least one interchangeable buffer plate is designed to enhance the longevity and integrity of the containment shell. The interchangeable buffer plate having a temperature resistant side is in contact with and bolted to at least one side of the containment shell. The at least one bimetallic band or cable being curved and includes a higher and a lower linear coefficient of thermal expansion. A gear assembly having a bevel gear and a stationary gear is adapted to be mounted on the support and meshing with the bimetallic band to control the speed of the device. These bevel gears also serve for direct and/or indirect draw on power from the subsequent rotation due to the thermal differentials. Speed is controlled by the at least one band or cable made up of different metallic alloys being fully or partially engaged with the at least one buffer plate attached to the containment shell. The gear assembly is being implemented for change in revolutions per minute (RPM). The at least one gear shaft is attached to the bevel gear to rotate around an axel shaft. The at least one control arm controls the gear assembly as well as the at least one bimetallic band or cable which ultimately control the speed at which the device operates. An ejector remotely operable for pushing a previously retrieved spent fuel out of the containment shell is in an open and ready position in front of the containment shell. The device has a potential to consume many materials deemed as waste from various stockpiles and/or from power plants as high level radioactive substances to power itself and subsequently create power from sources of energy otherwise unattainable. Also it has the ability to power select devices being used at power plants that would necessitate motor-driven capabilities even in conjunction with a vehicle, for example, turbines, fuel cells, propellers and/or tires.

The present invention discusses in detail for better energy consumption from the radioactive resources and decreases the national stockpiles of hazardous radioactive waste.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 illustrates a perspective view of a device according to a preferred embodiment of the present invention except for the containment shell;

FIG. 2 illustrates a perspective view of a containment shell according to the preferred embodiment of the present invention;

FIG. 3A illustrates a front view perspective view of the containment shell according to the preferred embodiment of the present invention;

FIG. 3B illustrates a front view perspective of the containment shell with buffer plate according to the preferred embodiment of the present invention;

FIG. 3C illustrates a front perspective view of the Impacter/Ejector which also doubles as the console for which the operator controls the device which necessitates it being placed in front of the containment shell according to the preferred embodiment of the present invention;

FIG. 4 illustrates a front view of the bevel gear assembly for the energy transfer device(turbines, fuel cells, propellers and/or tires) according to the preferred embodiment of the present invention; and

FIG. 5 illustrates a side view of a device according to a preferred embodiment of the present invention except for the containment shell, refer to FIG. 2 to complete entire picture of the preferred embodiment of the containment shell for the present invention.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

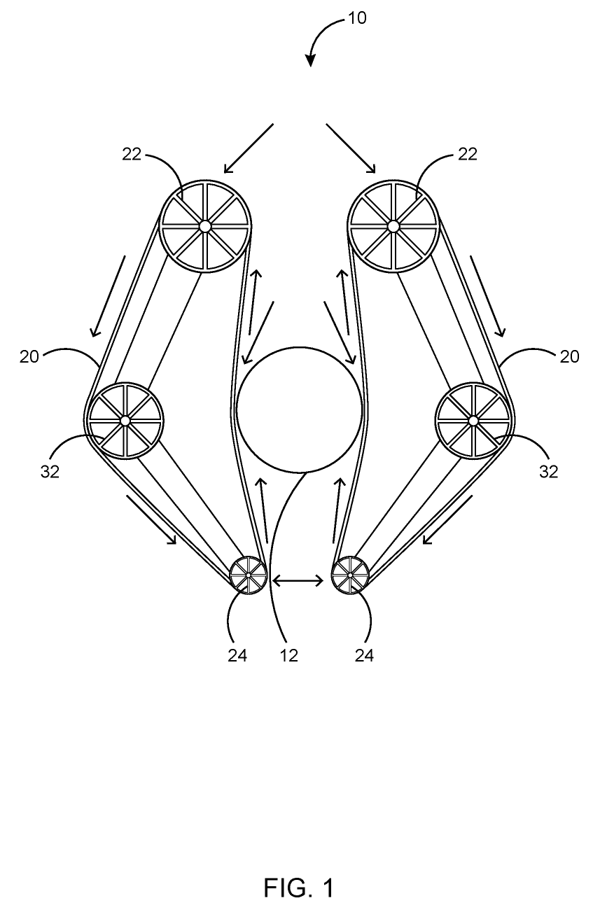

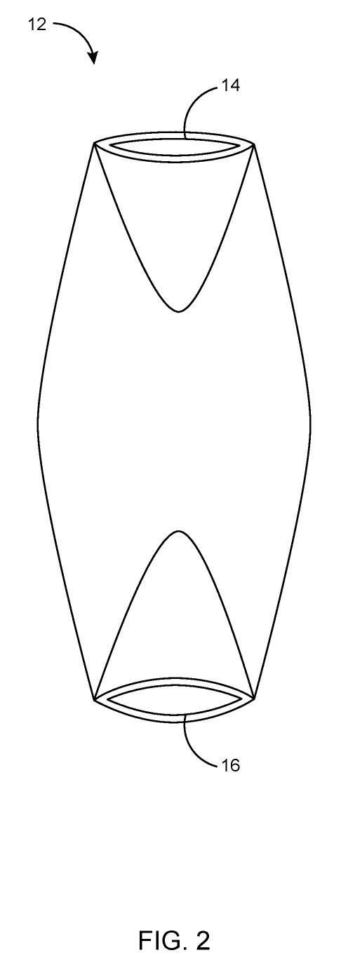

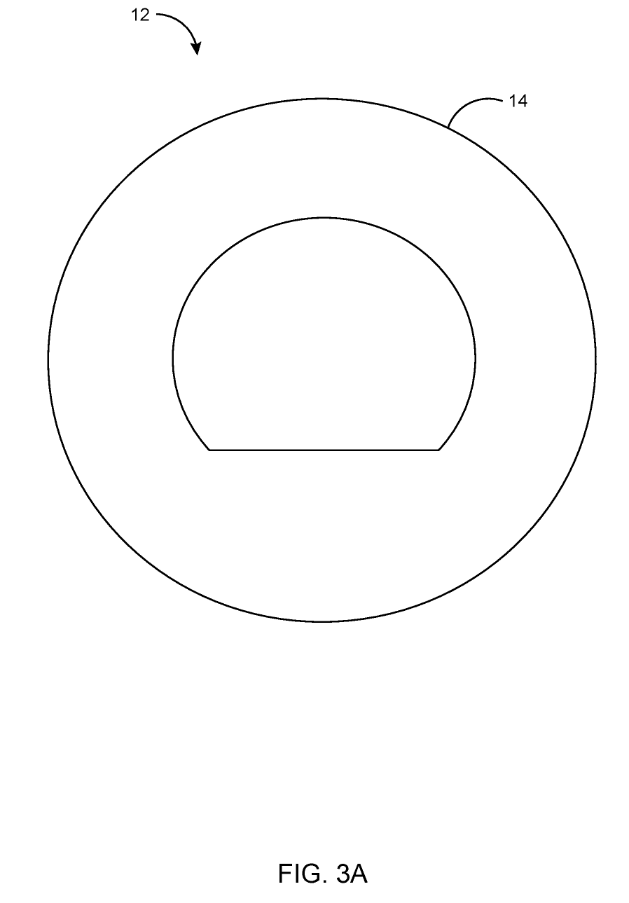

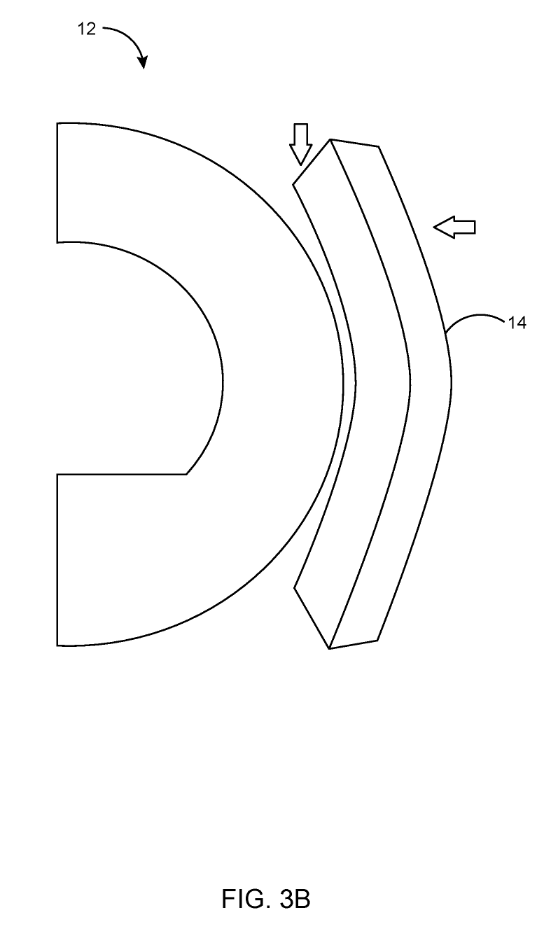

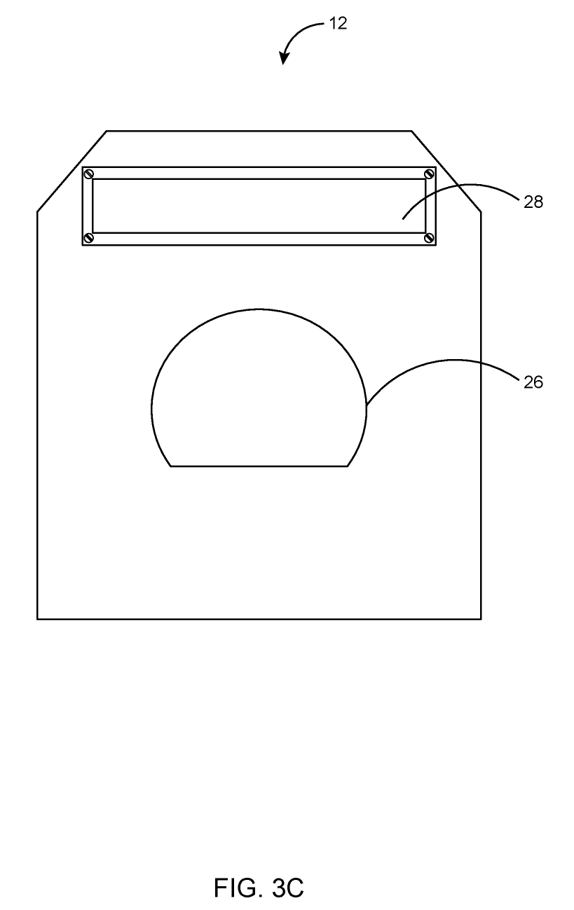

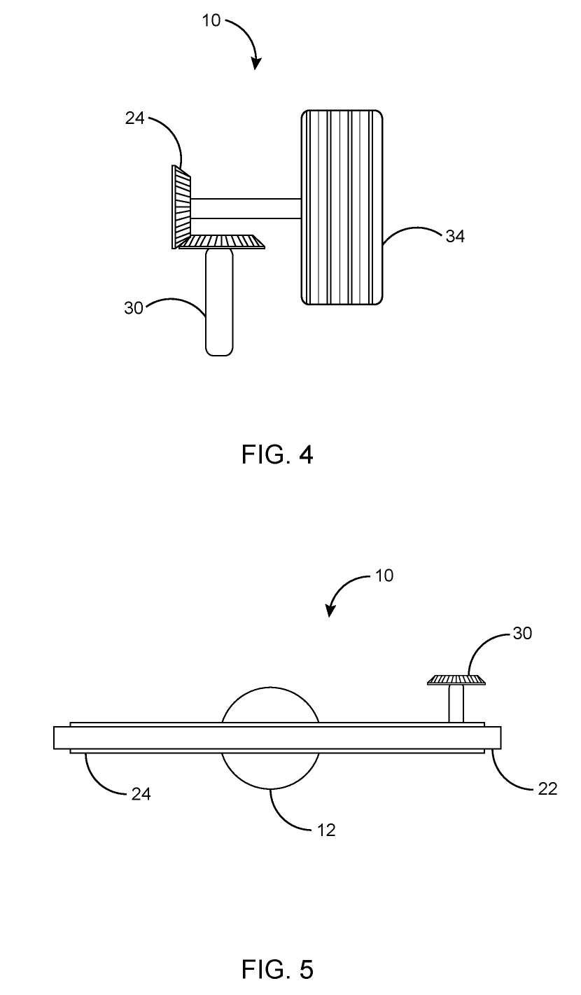

Referring to FIG. 1 illustrates a perspective view of a device 10 in accordance with a preferred embodiment of the present invention, taking into consideration the aspect of the containment shell being 12 that of FIG. 2. The device 10 for reclamation of a radioactive high level waste (HLW) for energy consumption comprises a containment shell (See FIG. 2) 12 for storage of radioactive material. The containment shell 12 comprises a front shell lid for closing/opening 14 (See FIG. 2) having an opening to push the radioactive material in one direction and dispose the radioactive material out into a secondary back shell lid 16 for containment inside a secondary diminished radioactive storage container. The at least one interchangeable buffer plate (Shown in FIG. 3B as #14) enhances the longevity and integrity of the containment shell 12. The interchangeable buffer plate having a temperature resistant side is in contact with and bolted to at least one side of the containment shell 12. The interchangeable buffer plate having a side with high friction durability is in contact with at least one side of the bimetallic band or cable 20 in FIGS. 1 and 22 in FIG. 5. The at least one bimetallic band or cable 20 in FIGS. 1 and 22 in FIG. 5 being curved and having a higher and a lower linear coefficient of thermal expansion. The dimension of the at least one bimetallic band 20 in FIGS. 1 and 22 in FIG. 5 depends upon the size of the containment shell 12. A gear assembly (22 24 & 32 in FIG. 1) having a pivot gear 24 a distancing gear 32 and a stationary gear 22 is adapted to be mounted on the support and meshing with the at least one bimetallic band 20 in FIGS. 1 and 22 in FIG. 5 to control the speed of the device 10. The gear assembly 22 24 & 32 being implemented for change in revolutions per minute (RPM). The at least one gear shaft (Shown in FIG. 4 as #30) attached to the stationary bevel gear 24 on FIG. 4 rotates on bevel gear 30(See FIG. 4) wherein the axel shaft 30 being externally installed to the device 10. The at least one control arm is operable to control the gear assembly 22 24 & 32 for FIG. 1. The at least one control arm also controls the at least one bimetallic band or cable 20 for FIGS. 1 and 22 for FIG. 5 which ultimately control the speed at which the device 10 operates. An ejector 26 (See FIG. 3C) remotely operable for pushing a previously retrieved spent fuel is in a ready position in front of the containment shell 12. The device 10 has a potential to consume many materials deemed as waste from various stockpiles and/or from power plants as high level radioactive substances to power itself and subsequently create power for consumption from sources of energy deemed otherwise unattainable. Also it has the ability to power select devices being used at power plants that would necessitate motor-driven capabilities even in conjunction with a vehicle, for example, turbines, fuel cells, propellers and/or tires

Referring to FIG. 2 illustrates a perspective view of the containment shell 12 in accordance with a preferred embodiment of the present invention. The containment shell 12 is utilized for storing and housing the radioactive material. The containment shell 12 comprises a first front shell lid 14 having an opening to push the radioactive material in one direction and to dispose the radioactive material out a second back shell lid 16. The containment shell 12 is designed as a torpedo shape to incorporate the best suited geometric feature, i.e., to utilize most available surface area. The size dimension of the containment shell 12 depends upon the level of reclamation process of the radioactive substances. The containment shell 12 ensures smoother transfer of the radioactive waste and also streamlines the process of isotope storage and removal. The containment shell 12 prevents a leakage radiation. The interior shape of the containment shell 12 is not circular to ensure utmost safety throughout the variety of loading particles from different facilities FIG. 3A. The interior part of the shell 12 FIG. 3A is designed to account for changes in a center of gravity. The at least one interchangeable buffer plate to enhance the longevity and integrity of the containment shell 12, the at least one interchangeable buffer plate having a temperature resistant side is in contact with and bolted to at least one side of the containment shell 12, the interchangeable buffer plate provides an enhanced surface to facilitate a mechanical interaction within the device 10.

FIGS. 3A and 3B illustrate cross-sectional perspective views of the containment shell 12 in accordance with the preferred embodiment of the present invention. The containment shell 12 comprises a first closed lid 14 and a second closed lid 16. The device uses the impactor/ejector FIG. 3C to compact the radioactive material in the containment shell 12 and ejects the radioactive material out the second lid 16 after the reclamation process is all finished. The first front closed lid 14 and the second back closed lid 16 are part of the safety barrier console of the containment shell 12. The safety glass 28 FIG. 3C is utilized to view the application of isotope storage and removal of radioactive substances safely from the operating console. An ejector 26 is a second device which is externally installed and remotely operable for pushing a previously retrieved spent fuel out of the containment shell 12. The device 10 reclaims the energy given off of the contained radioactive isotopes for power.

FIG. 4 illustrates a front view and a side view of the bevel gear assembly in accordance to the power output converter 34 in FIG. 4 in accordance with the preferred embodiment of the present invention. The device 10 comprises the containment shell 12 in FIG. 2 for storage of radioactive material. The containment shell 12 comprises the first closed/opened lid 14 having an opening to push the radioactive material in one direction and dispose the radioactive material out of a second closed/opened lid 16. The at least one interchangeable buffer plate enhances the longevity and integrity of the containment shell 12. The interchangeable buffer plate having a temperature resistant side is in contact with and bolted to at least one side of the containment shell 12. The at least one bimetallic band or cable 20 in FIGS. 1 and 22 in FIG. 5 is being curved and having a higher and a lower linear coefficient of thermal expansion. A gear assembly 22 24 & 32 having a pivot gear 24 a distancing gear 32 and a stationary gear 22 is adapted to be mounted on the support and meshing with the bimetallic band 20 in FIGS. 1 and 22 in FIG. 5 to power devices such as turbines, fuel cells, propellars, tires etc. The at least one control arm is provided to control the gear assembly 22 24 & 32. The at least one control arm also controls the at least one bimetallic band 20 in FIGS. 1 and 22 in FIG. 5 which ultimately controls the speed at which the device operates. The present invention discuss in detail the process of decaying radioactive isotopes and used HLW in any vast spent stores more efficiently. The device 10 provides a method to create better energy consumption from the radioactive residuals and to decrease the national stock piles of hazardous radioactive wastes.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A device for reclamation of a radioactive high level waste (HLW) for energy consumption comprising:
a containment shell for storage of radioactive material, the containment shell comprising a first lid for closing and opening having an opening to push the radioactive material in one direction and dispose the radioactive material in a second direction out the second lid for closing and opening;
at least one interchangeable buffer plate to enhance the longevity and integrity of the containment shell, the interchangeable buffer plate having a temperature resistant in contact with and bolted to at least one side of the containment shell;
at least one bimetallic band or cable being curved and having a higher and a lower linear coefficient of thermal expansion, the dimension of the at least one bimetallic band or cable depends upon the size of the containment shell; and
a gear assembly having a bevel gear and a stationary gear adapted to be mounted on the support and meshing with the at least one bimetallic band to control the speed of the device.

2. The device of claim 1 wherein the device houses the radioactive material in the containment shell and extracts the radioactive material with the impactor/extractor out of the second opening/closing lid of the containment shell.

3. The device of claim 1 wherein the containment shell prevents a leakage radiation.

4. The device of claim 1 wherein the device being designed as a torpedo to incorporate optimal surface area.

5. The device of claim 1 wherein the interchangeable buffer plate provides an enhanced surface to facilitate a mechanical interaction within the device.

6. The device of claim 1 wherein the gear assembly being implemented for change in revolutions per minute (RPM).

7. The device of claim 1 wherein the axel shaft being externally installed to the device.

8. The device of claim 7 wherein the axel shaft determines the mode and amount of energy transferred to other devices such as turbines, fuel cells, propellars and/or tires.

9. The device of claim 1 wherein the device has at least one gear shaft attached to the bevel gear to rotate around an axel shaft and at least one control arm to control the gear assembly; and an ejector remotely operable for pushing a previously retrieved spent fuel out of the containment shell.

10. The device of claim 1 wherein the device with the containment shell, the at least one interchangeable buffer plate, the at least one bimetallic band or cable, the gear assembly, the control arm and the ejector operates in whole to focuses the removal of the spent fuel and consuming the spent fuel for energy and diminishing its radioactivity.

11. A device for reclamation of a radioactive high level waste (HLW) for energy consumption comprising:
a containment shell for a storage of radioactive material, the containment shell comprising a first closed/open lid shell having an opening to push the radioactive material in one direction and dispose the radioactive material out a second closed/opened shell lid; the containment shell being designed to prevent a leakage radiation;
at least one interchangeable buffer plate to enhance the longevity and integrity of the containment shell, the at least one interchangeable buffer plate having a temperature resistant in contact with and bolted to at least one side of the containment shell, the interchangeable buffer plate provides an enhanced surface to facilitate a mechanical interaction within the device of the bimetallic band or cable;
at least one bimetallic band or cable being curved and having a higher and a lower linear coefficient of thermal expansion, the dimension of the at least one bimetallic band or cable depends upon the size of the containment shell; and
a gear assembly having a bevel gear and a stationary gear adapted to be mounted on the support and meshing with the at least one bimetallic band or cable to control the speed of the device, the gear assembly being implemented for change in revolutions per minute (RPM).

12. The device of claim 11 wherein the device housing the radioactive material in the containment shell and extract the radioactive material out of the second open/closed lid of the containment shell.

13. The device of claim 11 wherein the containment shell prevents a leakage radiation.

14. The device of claim 11 wherein the device being designed as a torpedo to incorporate optimal surface area.

15. The device of claim 11 wherein the interchangeable buffer plate provides an enhanced surface to facilitate a mechanical interaction in the device for bimetallic band and/or cable.

16. The device of claim 11 wherein the gear assembly being implemented for change in revolutions per minute (RPM).

17. The device of claim 11 wherein the axel shaft determines the mode and amount of energy transferred to other devices such as turbines, fuel cells, propellars and/or tires.

18. The device of claim 11 whereby the device with the containment shell, the at least one interchangeable buffer plate, the at least one bimetallic band or cable, the gear assembly, the control arm and the ejector operates in whole to focus the housing and removal of the spent fuel and extract energy via heat to create power.

19. The device of claim 11 wherein the device has at least one gear shaft attached to the bevel gear to rotate around an axel shaft; the axel shaft being externally installed to the device; at least one control arm to control the gear assembly; and an ejector remotely operable for pushing a previously consumed spent fuel out of the containment shell. device of claim 1 wherein the containment shell prevents a leakage radiation.
